(19) United States
(12) Patent Application Publication
(10) Pub. No.: US 2009/0307442 A1
(43) Pub. Date: Dec. 10, 2009

(54) Memory Access Control

(76) Inventor: Balbir Singh, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/091,172

(22) PCT Filed: Oct. 25, 2005
(86) PCT No.: PCT/IN05/00343

§ 371 Date: Jul. 8, 2008

(51) Int. Cl. G06F 12/00

(52) U.S. Cl. 711/154; 711/E12.001

(57) ABSTRACT

An embodiment of a method of controlling memory access includes an initial step of receiving a first request to control memory access. The embodiment of the method also includes the step of creating an instance of a data structure based on the first request. In addition to the previous two steps the embodiment of the method also includes the steps of receiving a second request to access a memory, and examining the instance of the data structure to determine whether the memory can be accessed.

### FIELD OF THE INVENTION

The present invention relates generally to the field of controlling access to memory and more particularly, but not exclusively, to the field of memory access control for concurrent computer programs.

### BACKGROUND OF THE INVENTION

Traditionally, computer programs have sequentially executed a series of tasks (operations) one after the other such that a new task is not initiated until a previous task had been completed. There are some instances when it is desirable to sequentially execute tasks such as, for example, when a task involves processing data that is created on the completion of some other task. However, in many instances a task may not be dependant on another task being completed before it can be executed. As a consequence, sequential execution of tasks may take more time than is actually necessary to complete all of the tasks.

Having realized that sequential execution of tasks may take more time than is actually required, researchers developed the concept of concurrent computer programs. A concurrent program is capable of executing multiple tasks concurrently. Concurrent tasks are sometimes referred to as separate threads of execution. As a consequence, a concurrent computer program is likely to require less time to complete a series of tasks than a computer program that sequentially executes the same tasks.

An issue associated with concurrent programmes is that concurrent tasks need to be carefully managed (or synchronized) to ensure they do not interfere with each other. Concurrent tasks may interfere with each other when, for example, the tasks simultaneously access memory. Simultaneous memory access can be a problem, particularly when it involves simultaneous read and write operations, because it can lead to the retrieval of erroneous data from memory.

Various memory access control techniques (locking policies) have been devised to address the problems associated with simultaneous memory access. These techniques include, for example, semaphores and spin locks. Typically, when developing a concurrent program a designer (system architect) will select one or more memory access control techniques to be used in the concurrent program. Details of the selected memory access control techniques and the region of memory to be controlled will then be conveyed to a programmer who will develop the appropriate software for controlling memory access.

It is not uncommon for a programmer to be asked to incorporate many different memory access control techniques into a single concurrent program. As a result it can be very difficult for the programmer to keep track of which memory access control techniques are being used and which region of memory each control technique protects.

### SUMMARY OF THE INVENTION

An embodiment of a method of controlling memory access includes an initial step of receiving a first request to control memory access. The embodiment of the method also includes the step of creating an instance of a data structure based on the first request. In addition to the previous two steps the embodiment of the method also includes the steps of receiving a second request to access a memory, and examining the instance of the data structure to determine whether the memory can be accessed.

The present invention will be more fully understood from the following description of a specific embodiment. The description is provided with reference to the accompanying drawings.

### A BRIEF DESCRIPTION OF THE DRAWINGS

FIG. 1 depicts a computing device in accordance with an embodiment of the present invention;

FIG. 2 is a flow chart of various steps performed by the computing device of FIG. 1 in accordance with an embodiment of the present invention;

FIG. 3(a) and FIG. 3(b) are representations of data structures used by the computing device of FIG. 1 in accordance with an embodiment of the present invention;

FIG. 4 is a flow chart of several steps performed by the computing device of FIG. 1 in accordance with an embodiment of the present invention; and

FIG. 5 is a flow chart of various steps performed by the computing device of FIG. 1 in accordance with an embodiment of the present invention.

### DETAILED DESCRIPTION

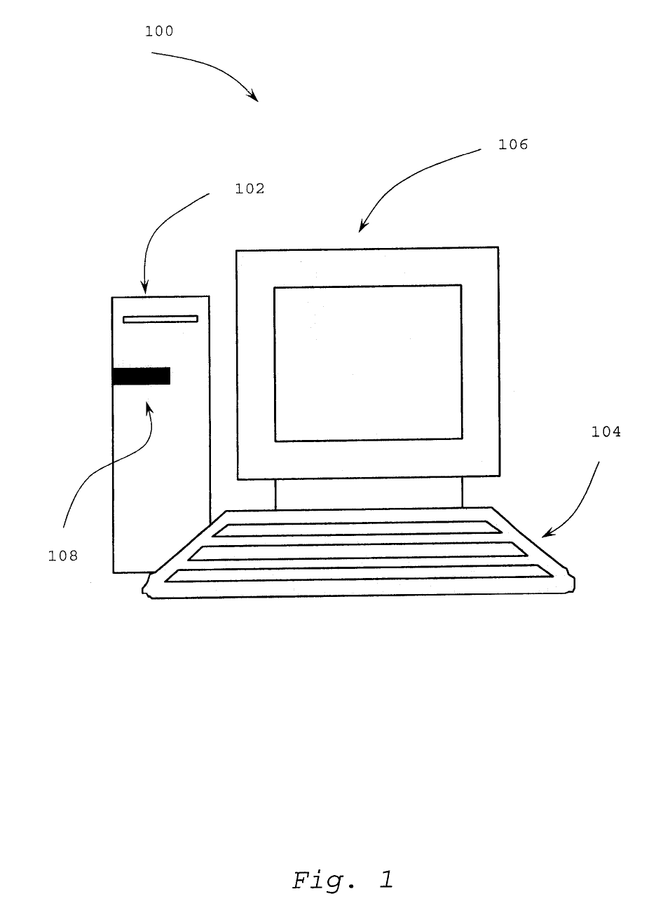

With reference to FIG. 1, a computing device 100 according to the embodiment of the present invention is in the form of a personal computer. As such the computing device 100 includes a motherboard and numerous electronic components installed on the motherboard. The motherboard and numerous electronic components are located in the main housing 102 of the computing device 100. The electronic components installed on the motherboard include, for example, a central processing unit, random access memory, a graphics card, and a network interface. The computing device 100 also includes a hard disk and a power supply, which are electrically coupled to the motherboard and also located in the main housing 102. The computing device 100 also includes a keyboard 104, a mouse and a monitor 106. The keyboard 104 and the mouse are electrically coupled to the motherboard, while the monitor 106 is electrically coupled to the graphics card.

In addition to the hardware described in the previous paragraph, the computing device 100 also includes an operating system in the form of Linux, which resides on the hard disk of computing device 100. When executed, the operating system cooperates with the hardware of the computing device 100 to provide an environment in which software applications can be executed. In this regard, the hard disk of the computing system 100 is loaded with a concurrent computer program that includes a memory access control means 108, in the form of a software module, which essentially controls access to memory such that concurrently executing tasks of the computer program do not simultaneously access the memory.

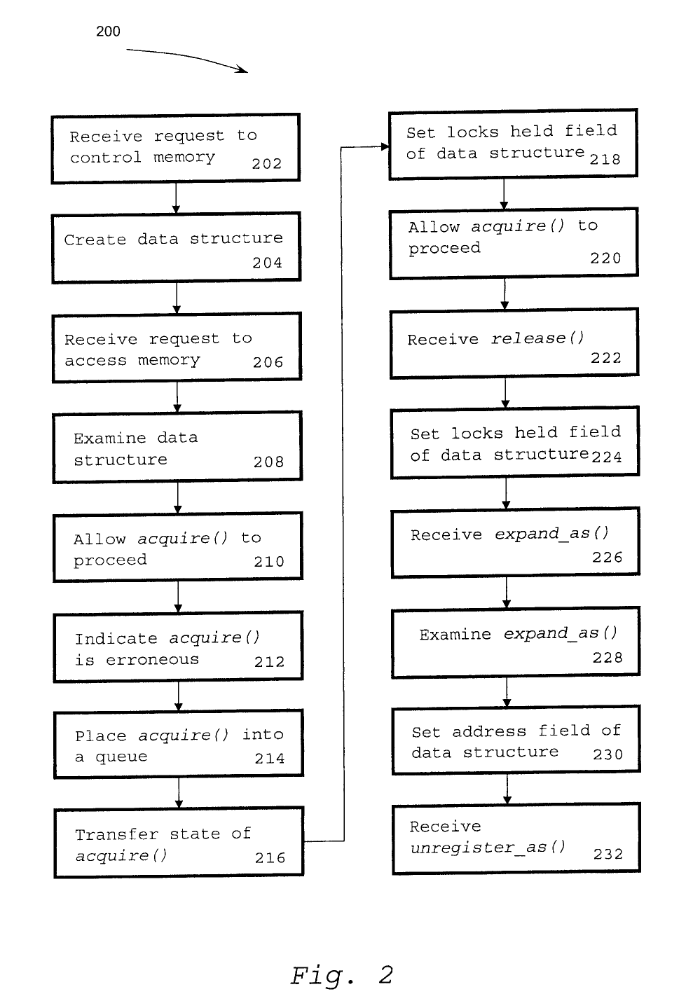

To control access to memory the memory access control means 108 is arranged to perform various steps, which are set out in the flow chart 200 of FIG. 2. The first step 202 involves receiving one or more requests to control memory access. The requests are in the form of a call to a register_as(base address, offset address, locking policy) function. The call to the register_as( ) function is performed shortly after the concurrent computer program is executed. More specifically, the concurrent computer program makes the register_as( ) function call by invoking an initialization software module that contains the register_as( ) function call.

The register_as( ) has three parameters: base address; offset address; and locking policy. The base address parameter identifies the base address of a region of memory, while the offset address parameter identifies the upper limit of the region of memory. The locking policy parameter identifies the locking policy (or memory access control technique) that is to be used to control access to the region of memory defined by the base address and offset address parameters. The locking policy identified by the locking policy parameter can, for example, include semaphore, spin lock and atomic variable.

It is envisaged that the initialization software module, which contains the register_as( ) function call, is developed by the designer (system architect) responsible for overseeing the development of the concurrent computer program. The initialization software module is in the form of a text file. Once the designer completes the initialization software module, programmers are able to subsequently include the initialization module into the concurrent program by, for example, linking it when the concurrent program is being complied.

An advantage of using the initialization module, and more particularly the register_as( ) function, is that it effectively removes the need for programmers to know which memory access control techniques are to be used in the concurrent program and which regions of memory are associated with each of the access control techniques. Another advantage is that programmers can to use the address of the memory for which control is exerted. In this regard, it is envisaged that there would be a lock variable that represents the address to be controlled. As a result, programmers do not have to worry about which lock variable to use. In the absence of this embodiment, programmers may use the wrong locking policy or variable to obtain memory access. This embodiment attempts to avoid these problems by enabling programmers to pass only the address of the memory they wish to access.

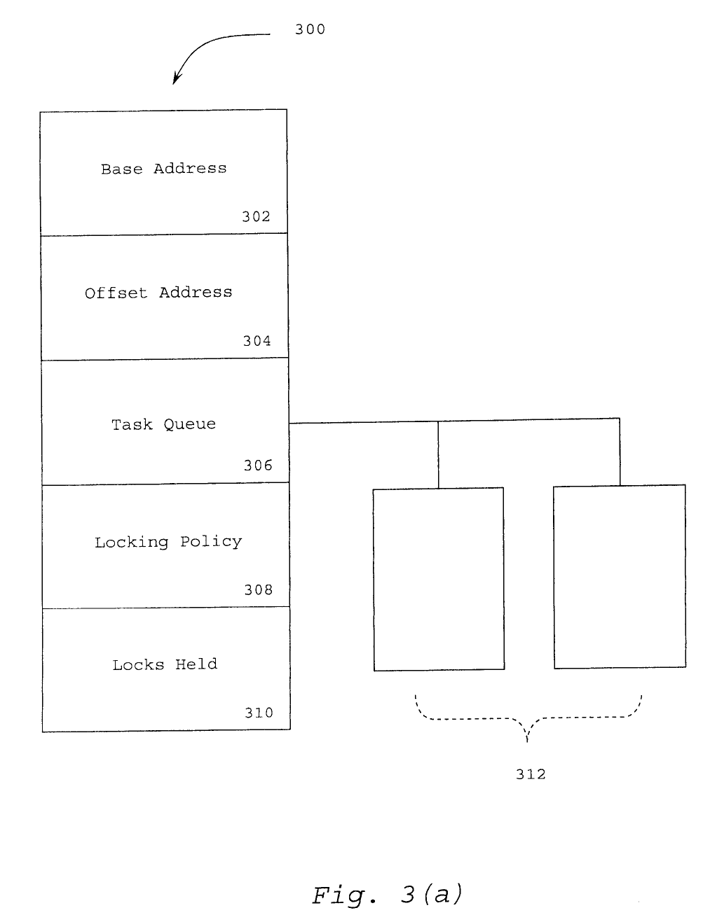

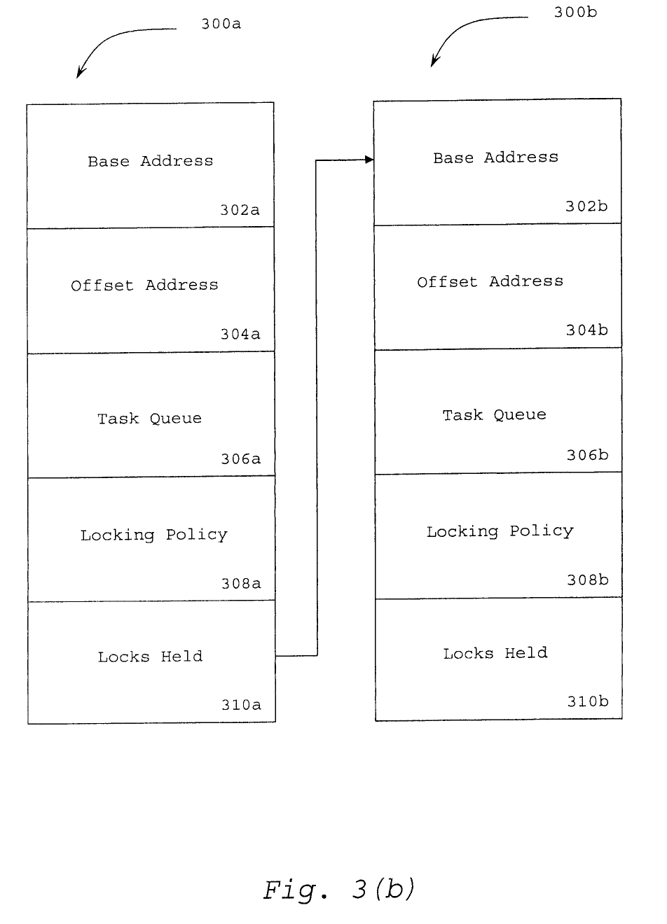

Following on from the previous step 202 of receiving the first request (the register_as( ) function), the memory access control means 108 performs the step 204 of creating an instance of a data structure 300, which is represented in FIG. 3, that is based on the first request, or more specifically, the three parameters accompanying the register_as( ) function. With reference to FIG. 3, the instance of the data structure 300 includes six fields 302 to 312 that are used to contain information about the called register_as( ) function. The first field 302 specifies the base address of a region of protected memory, while the second field 304 specifies the upper limit of the region of protected memory. The third field 306 contains a pointer to a queue of tasks waiting to access the region of protected memory defined by the first and second fields 302 and 304. The fourth field 308 identifies the type of policy being used to protect the region of memory defined by the first and second fields 302 and 304. The fifth field 310 is used to indicate whether the region of memory defined by the first and second fields 302 and 304 is accessible. Finally, the sixth field 312 is used to contain a pointer to another related data structure 300.

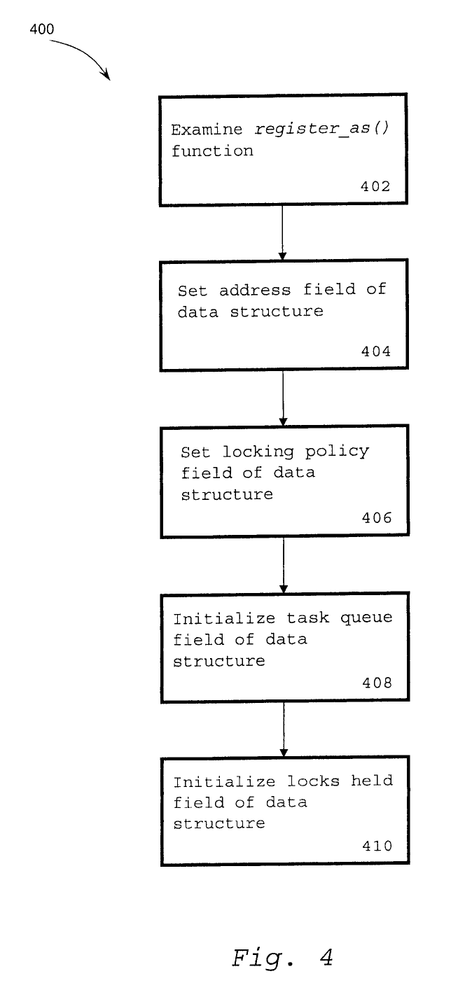

The step 204 of creating the instance of the data structure 300 involves several sub-steps, which are shown in the flow chart 400 of FIG. 4. The first of the sub-steps 402 involves examining the register_as( ) function to determine the region of memory and the locking policy that is to be used to control access to the region of memory. In an embodiment, in order to determine the region of memory and the locking policy the first of the sub-steps 402 further involves examining the base address, offset address, and locking policy parameters that accompany the register_as( ) function call.

In addition to the first sub-step 402, the step 204 of creating the instance of the data structure involves the sub-step 404 of setting the address fields 302 and 304 of the data structure 300 to identify the address region that was determined during the previous sub-step 402, and the sub-step 406 of setting the locking policy field 308 of the data structure 300 to identify the locking policy that was determined during the previous sub-step 402.

The step 204 also involves a couple of other additional sub-steps 408 and 410. One of the additional sub-steps 408 involves initializing the task queue field 306 of the data structure 300 to indicate no waiting tasks. The other additional step 410 involves initializing the locks held field 310 of the data structure 300 to indicate that the region of memory (identified by the address fields 302 and 304) is accessible.

Once the memory access control means 108 has performed the step 204 of creating the instance of the data structure 300, it is then ready to perform the step 206 of receiving a request to access memory. The request to access memory is in the form of an acquire(operation, address) function call. The operation parameter can be either read or write and specifies the type of access required to the memory, while the address parameter specifies the specific memory address for which read or write access is required. It is envisaged that the acquire( ) function could include another address parameter such that the acquire( ) function call specifies an address range to be accessed.

The acquire function call is made by the software of the concurrent program that is developed by the programmer as opposed to the designer who, as mentioned previously, develops the initialization software module and oversees the development of the concurrent computer program. Unlike existing methodologies for controlling access to memory, the acquire function does not contain a parameter that identifies the appropriate locking policy. Thus, the programmer is freed from having to know what locking policies are being used to control access to memory. Details of the locking policy are provided by the register_as( ) which is used by the designer.

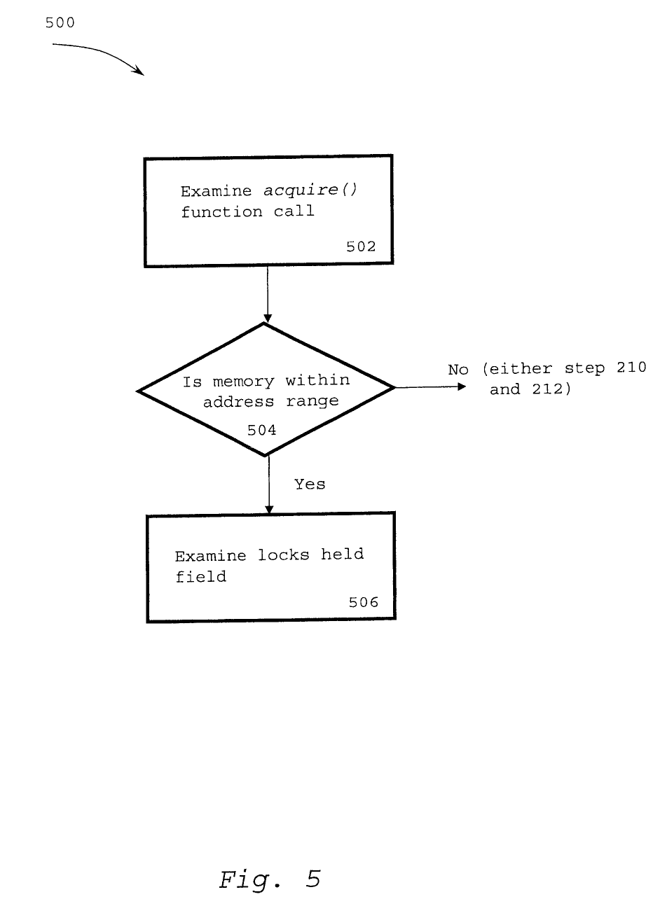

Subsequent to receiving a request to access memory (that is, a call to the acquire( ) function), the memory access control means 108 performs the step 208 of processing another data structure, such as a linked list, to find the instance of the data structure 300 for the request to access memory. If no data structure 300 is found an error signal can be issued, or alternatively, it can be assumed the memory is not protected and allow the request for memory access to proceed. Assuming the data structure 300 is found the next step 209 performed involves examining the instance of the data structure 300 (created during a previous step 204) to determine whether the memory identified by the address parameter of the acquire( ) function is accessible. In an embodiment, the step 208 of examining the data structure 300 involves several sub-steps, which are represented in the flow chart 500 of FIG. 5.

The first of the sub-steps 502 involves examining the acquire( ) function call to identify the memory address (or region of memory) that is to be accessed. This is achieved by examining the address parameter accompanying the acquire( ) function call. The next sub-step 504 performed is to determine whether the memory address identified during the previous sub-step 502 is within the address range specified by the address fields 302 and 304 of the data structure 300. If as a result of the previous sub-step 504 it is determined that the address is within the range of the address fields 302 and 304, the sub-step 506 of examining the locks held field 310 of the data structure 300 is performed. The purpose of examining the locks held field 310 is to determine whether the memory region identified by the address fields 302 and 304 are accessible. Typically, the memory region would not be accessible if another task was accessing the memory.

If, however, as a result of carrying out the sub-step 504 it is determined that the address (obtained during the earlier sub-step 502) is not within the range of the address fields 302 and 304, the memory access control means 108 is arranged to perform one of two steps 210 and 212. The first 210 of these steps involves allowing the acquire( ) function call to proceed so that it can access the memory identified by the associated address parameter. The first 210 of these steps effectively indicates that access to the memory is not controlled by a control technique. Alternatively, the second step 212 involves issuing an indication that the acquire( ) function call is erroneous. The indication is an error( ) function call that informs the concurrent program about the erroneous acquire( ) function call.

If it is determined, as a result of performing the last sub-step 506, the memory region identified by the address fields 302 and 304 cannot be accessed the memory access control means 108 performs the step 214 of placing the acquire( ) function call into a queue 314 and placing the queued acquire( ) function into a suspended state. To locate the queue 314 the memory access control means 108 examines the task queue field 306 of the data structure 300, which contains a pointer to the queue 314. Using the pointer, the memory access control means 108 places the acquire( ) function into the queue 314. To put the queued acquire( ) function into the suspended state the memory access control means 108 examines the locking policy field 308 to identify the locking policy.

Once the locking policy has been identified the memory access control means 108 places the acquire( ) function into the suspended state based on the identified locking policy. If, for example, the identified locking policy is a semaphore then placing the acquire( ) function into the suspended state involves putting the function to sleep. Alternatively, if the identified locking policy is a spin lock then placing the acquire( ) function into the suspended state involves making the function spin for memory access.

When the region of memory (identified by the address fields 302 and 304 of the data structure 300) is unlocked for access (which is described in more detail in the following paragraphs), the memory access control means 108 proceeds to check the queue 314 to determine whether there are any queued tasks (acquire( ) function calls). On determining that there is a queued acquire( ) function call, the memory access control means 108 proceeds to perform the step 216 of retrieving the acquire( ) function from the queue 314 and transferring the acquire( ) function call, which was previously put into the suspended state, from the suspended state to an active state. In an embodiment, the step 216 of placing the acquire( ) function call into the active state involves, waking the acquire( ) function if the locking policy specified in the policy field 308 of the data structure 300 is semaphore or to take the acquire( ) function out of a spin if the policy field 308 is a spin lock.

Following on from the previous step 216 the memory access control means 108 carries out the step 218 of setting the locks held field 310 of the data structure 300 to indicate which addresses in the range specified by address fields 302 and 304 are not accessible. At this point the memory access control means 108 also carries out the step 220 of allowing the acquire( ) function call to proceed so that the memory (identified by the associated address parameter) can be accessed.

When the concurrent computer program has completed accessing memory (by way of calling the acquire( ) function), the concurrent program can ‘unlock’ the region of memory for further access by issuing the memory access control means 108 with a request indicating that memory access is no longer required. In this regard, the request is in the form of a release (operation, address). The operation parameter specifies the type of operation that is being released; that is, either read or write. The address parameter is the address that is being freed. The address parameter can also be an address range.

In view of the concurrent computer program's ability to call the release( ) function, the memory access control means 108 is capable of performing the step 222 of receiving the release( ) function. In response to receiving the release( ) function the memory access control means 108 performs the step 224 of setting the locks held field 310 of the data structure 300 to indicate that the memory (identified by the address parameter of the release( ) function) is accessible. Following on from the step 224 of setting the locks held field 310 the memory access control means 108 can, for example, proceed to perform the steps 216 to 220 so that queued acquire( ) functions are provided with access to the memory.

At any point after the concurrent computer program has called the register_as( ) function the program can alter details of the memory specified in the address fields 302 and 304 of the data structure 300. In effect, this allows the concurrent computer program to change the region of memory that is protected by the locking policy specified in the locking policy field 308 of the data structure 300. To alter the details of the address the concurrent computer program issues a request to alter the address details. The request is in the form of an expand_as( )address, address, new address range, locking policy). The two address parameters represent the address range that was originally specified in the register_as( ) function call, while the new address range is the new address of the memory. The locking policy parameter also specified the locking policy to be used to control access to the address specified by the new address range. The two address parameters of the expand( ) function are used by the memory access control means 108 to locate the data structure 300, which is done by comparing the address parameters to the address fields 302 and 304 of the data structure 300.

Given that the concurrent computer program has the ability to call the expand_as( ) function the memory access control means 108 is arranged to perform the step 226 of receiving the expand_as( ) function. In addition to receiving the expand_as( ) function, the memory access control means 108 also performs the step 228 of examining a received expand_as( ) function to determine the new address range for the address fields 302 and 304 of the data structure 300. The step 228 of examining the received expand_as( ) function is performed if the new address range is contiguous to an address specified in the address fields 302 and 304 of an existing data structure 300. If this is not the case then a new data structure 300 is created and linked using the next field 312 of an existing data structure 300. The next field 312 of an existing data structure 300 identifies the address of the new data structure 300. In particular, the memory access control means 108 examines the new address range parameter of the expand_as( ) function. Subsequent to the previous step 228 the memory access control means 108 performs the step 230 of setting the address fields 302 and 304 of the data structure 300 to reflect the new address obtained during the last step 228.

In addition to being able to establish access control over a region of memory, the concurrent computer program is also capable of removing control over the region of memory. In this regard, the concurrent computer program is capable of issuing the memory access control means 108 with a request to remove control over the memory. The request to remove control is in the form of an unregister_as(address) function call. The address parameter is the address from which access control is to be removed. Consequently, the memory access control means 108 is arranged to perform the step 232 of receiving the unregister_as( ) function call. On receiving the unregister_as( ) function call the memory access control means 108 deletes the data structure 300.

The present embodiment has been described in the context of a single data structure 300 for the sake of clarity. However, the memory access control means 108 is in fact arranged to create a plurality of data structures 300, which are illustrated in FIG. 3(b). Each data structure 300 is essentially created by the memory access control means 108 each time a register_as( ) function is received for which no suitable existing data structure 300 exists. This, for example, might be when no data structure has address fields 302 and 304 that correspond with the address parameter of the register_as( ) function call.

Each of the data structures 300 are linked together by means of a linked list, which enables the memory access control means 108 to readily search through the data structures 300 in response to, for example, receiving an acquire( ) function call. It will be appreciated that the present invention is not restricted to the linked list and an alternative embodiment of the invention may employ, for example, a treap.

An embodiment of a computing device includes a memory access control means 108 arranged to perform the initial step of receiving a first request to control memory access. The memory access control means 108 is also arranged to carry out the step of creating an instance of a data structure based on the first request. In addition to the previous two steps the memory access control means 108 is capable of performing the steps of receiving a second request to access a memory and examining the instance of the data structure to determine whether the memory can be accessed.

An embodiment of a computer program includes at least one instruction arranged to cause a computing device to perform the step of receiving a first request to control memory access. The instruction is also arranged to cause the computing device to create an instance of a data structure based on the first request. In addition to the previous two steps, the instruction is also arranged to cause the computing device to perform the steps of receiving a second request to access a memory and examining the instance of the data structure to determine whether the memory can be accessed.

While the present invention has been described with reference to the aforementioned embodiment, it will be understood by those skilled in the art that alterations, changes and improvements may be made and equivalents may be substituted for the elements thereof and steps thereof without departing from the scope of the present invention. In addition, many modifications may be made to adapt to a particular situation or material to the teachings of the present invention without departing from the central scope thereof. Such alterations, changes, modifications and improvements, though not expressly described above, are nevertheless intended and implied to be within the scope and sprit of the invention. Therefore, it is intended that the invention not be limited to the particular embodiments disclosed as the best mode contemplated for carrying out this invention, but that the invention will include all embodiments falling within the scope of the independent claims.

1. A method of controlling memory access, the method comprising the steps of:
receiving a first request to control memory access;
creating an instance of a data structure based on the first request;
receiving a second request to access a memory; and
examining the instance of the data structure to determine whether the memory can be accessed.

2. The method as claimed in claim 1, wherein the step of creating the instance of the data structure comprises the steps of:
examining the first request to identify a first memory address and a memory access control technique;
setting at least one first field of the instance to identify the first memory address; and
setting a second field of the instance to identify the memory access control technique.

3. The method as claimed in claim 2, wherein the step of examining the instance of the data structure comprises the steps of:
examining the second request to identify a second memory address;
determining whether the second memory address corresponds to the first field of the instance; and
upon determining that the second memory address corresponds to the first field of the instance, examining a third field of the instance to determine whether the second memory address can be accessed.

4. The method as claimed in claim 3, comprising the steps of:
providing access to the second memory address in relation to the second request; or
issuing an indication that the second request is erroneous,
wherein the steps of providing access and issuing the indication are carried out if it is determined that the second memory address does not correspond to the first field of the instance.

5. The method as claimed in claim 3, comprising the step of placing the second request in a suspended state, which is based on the memory access control technique identified by the second field of the instance, if as a result of examining the third field it is determined that the second memory address cannot be accessed.

6. The method as claimed in claim 5, comprising the steps of:
transferring the second request from the suspended state to an active state if an examination of the third field of the instance indicates that the second memory address can be accessed;
setting the third field of the instance to indicate that the first memory address cannot be accessed; and
providing access to the second memory address in relation to the second request when in the active state.

7. The method as claimed in claim 3, comprising the steps of:
setting the third field of the instance to indicate that the first memory address cannot be accessed if as a result of examining the third field it is determined that the second memory address can be accessed; and
providing access to the second memory address in relation to the second request.

8. The method as claimed in claim 6, comprising the steps of:
receiving a third request indicating that access to the memory is not required; and
setting the third field of the instance to indicate that the first memory address can be accessed.

9. The method as claimed in claim 2, comprising the steps of:
receiving a fourth request to alter details of the memory;
examining the third request to obtain a third memory address; and
setting the first field of the instance to identify the third memory address.

10. The method as claimed in claim 1, comprising the steps of:
receiving a forth request to remove control over memory access; and
deleting the instance of the data structure.

11. The method as claimed in claim 1, comprising the step of processing another data structure to locate the data structure.

12. A computing device comprising a memory access control means arranged to perform the steps of:
receiving a first request to control memory access;
creating an instance of a data structure based on the first request;
receiving a second request to access a memory; and
examining the instance of the data structure to determine whether the memory can be accessed.

13. The computing device as claimed in claim 12, wherein the memory access control means is arranged such that the step of creating the instance of the data structure comprises the steps of:
examining the first request to identify a first memory address and a memory access control technique;
setting at least one first field of the instance to identify the first memory address; and
setting a second field of the instance to identify the memory access control technique.

14. The computing device as claimed in claim 13, wherein the memory access control means is arranged such that the step of examining the instance of the data structure comprises the steps of:
examining the second request to identify a second memory address;
determining whether the second memory address corresponds to the first field of the instance; and
upon determining that the second memory address corresponds to the first field of the instance, examining a third field of the instance to determine whether the second memory address can be accessed.

15. The computing device as claimed in claim 14, wherein the memory access control means is arranged to perform the steps of:
providing access to the second memory address in relation to the second request; or
issuing an indication that the second request is erroneous,
wherein the steps of providing access and issuing the indication are carried out if it is determined that the second memory address does not correspond to the first field of the instance.

16. The computing device as claimed in claim 14, wherein the memory access control means is arranged to perform the step of placing the second request in a suspended state, which is based on the memory access control technique identified by the second field of the instance, if as a result of examining the third field it is determined that the second memory address cannot be accessed.

17. The computing device as claimed in claim 16, wherein the memory access control means is arranged to perform the steps of:
transferring the second request from the suspended state to an active state if an examination of the third field of the instance indicates that the second memory address can be accessed;
setting the third field of the instance to indicate that the first memory address cannot be accessed; and
providing access to the second memory address in relation to the second request when in the active state.

18. The computing device as claimed in claim 14, wherein the memory access control means is arranged to perform the steps of:
setting the third field of the instance to indicate that the first memory address cannot be accessed if as a result of examining the third field it is determined that the second memory address can be accessed; and
providing access to the second memory address in relation to the second request.

19. The computing device as claimed in claim 17, wherein the memory access control means is arranged to perform the steps of:
receiving a third request indicating that access to the memory is not required; and
setting the third field of the instance to indicate that the first memory address can be accessed.

20. The computing device as claimed in claim 13, wherein the memory access control means is arranged to perform the steps of:
receiving a fourth request to alter details of the memory;
examining the third request to obtain a third memory address; and
setting the first field of the instance to identify the third memory address.

21. The computing device as claimed in claim 12, wherein the memory access control means is arranged to perform the steps of:
receiving a forth request to remove control over memory access; and
deleting the instance of the data structure.

22. The computing device as claimed in claim 12, wherein the memory access control means is arranged to perform the step of processing another data structure to locate the data structure.

23. A computer program product for controlling access to a memory comprising a computer usable medium having computer readable program means for causing a computer to perform the steps of:
receiving a first request to control memory access;
creating an instance of a data structure based on the first request;
receiving a second request to access a memory; and
examining the instance of the data structure to determine whether the memory can be accessed.

24. (canceled)

25. (canceled)

26. (canceled)

27. (canceled)

28. (canceled)

29. (canceled)

30. (canceled)

31. (canceled)

32. (canceled)

33. (canceled)
